(19) United States
(12) Patent Application Publication
(10) Pub. No.: US 2025/0238778 A1
(43) Pub. Date: Jul. 24, 2025

(54) Proximity Based User Authentication

(71) Applicant: Tegere, Inc., Gilbert, AZ (US)

(72) Inventors: Marwan Hannon, Gilbert, AZ (US); Devang Naik, Cary, NC (US)

(21) Appl. No.: 19/018,800

(22) Filed: Jan. 13, 2025

Related U.S. Application Data
(60) Provisional application No. 63/622,293, filed on Jan. 18, 2024.

(51) Int. Cl. G06Q 20/20; G06Q 20/32

(52) U.S. Cl. CPC G06Q 20/204; G06Q 20/3276; G06Q 20/3278

(57) ABSTRACT

A method of securing a transaction includes receiving data from a card at a terminal to initiate a transaction; providing a short-range communications link between a mobile device and the terminal, the mobile device being proximate to the terminal and associated with the user; the mobile device transmitting a unique code to the terminal; the terminal transmitting information including the unique code to a cloud based security application; the cloud based security application verifying the information; the cloud-based security application requesting approval of the mobile device; the mobile device approving the transaction; if authorization is provided, transmitting the authorization to the terminal and the terminal transmitting the unique code to the cloud-based security application; the cloud-based security application verifying the unique code; if verified, the security application transmitting an approval to the terminal; and the terminal completing the transaction when the approval is received.

### RELATED APPLICATIONS

The present application claims priority to U.S. Provisional Application 63/622,293, filed on Jan. 18, 2024, which is herein incorporated by reference in its entirety.

### TECHNICAL FIELD

Embodiments of the present invention are related to a security application to access a system.

### DISCUSSION OF RELATED ART

Computer systems are ubiquitous in modern society and control many important systems. These systems can be systems dedicated to data systems, for example financial or medical systems, that process highly confidential user information. Additionally, many of these systems can control complex systems, for example utility equipment such as pipelines or electrical grids, transportation systems, autonomous vehicles or other such systems.

These systems are increasingly at risk of attack from outside by bad actors. Breaches of these systems can result, and have resulted in, exposure of user confidential information (e.g., credit card information, personal information, medical information, etc.) as well as disruption of services that result from malignant access to the computer systems. In particular, the systems are increasingly at risk for fraud.

Credit card fraud, for example, is increasing at a staggering pace that appears to be unchecked by conventional multi-factor authentication (MFA) or password-based security methods. More sophisticated security measurers using stored consumer data (e.g., past two IP addresses identified with purchases or other data) run a high risk of false declines, preventing legitimate purchases from occurring, which deters nearly 30% of customers from returning for further purchase attempts.

According to a Nilson Report dated December 2021, in 2021 card fraud losses globally amounted to 32.34 Billion and 11.91 Billion in the US alone. By 2031, global fraud losses are expected to total 47.22 Billion on total card volume of 73.86 Trillion and 12.24 Billion on total volume tallying 19.38 Trillion in the US alone. Of these losses, card issuers bore an 88% share of fraudulent losses in 2020 and merchants and ATM acquirers assumed the other 12% of liability. Over the next decade, global card fraud losses for issuers, merchants and acquirers will total $397.40 Billion. Credit card fraud in the US accounted for 35.83% in global fraud in 2020.

Therefore, there is a need to develop security protocols to prevent malignant hacking in these computer systems.

### SUMMARY

In accordance with embodiments of the present disclosure, a method of securing a transaction is presented. The method includes receiving data from a card at a terminal to initiate a transaction; providing a short-range communications link between a mobile device and the terminal, the mobile device being proximate to the terminal and associated with the user; transmitting, by the mobile device, a unique code to the terminal; transmitting, by the terminal, information including the unique code to a cloud based security application; verifying, at the cloud based security application, the information; requesting, by the cloud-based security application, approval of the mobile device; approving, by the mobile device, the transaction; if authorization is provided, transmitting the authorization to the terminal; if authorization is provided, transmitting from the terminal the unique code to the cloud-based security application; verifying, at the cloud-based security application, the unique code; if verified, the security application transmitting an approval to the terminal; and completing the transaction, by the terminal, when the approval is received.

In some embodiments, the method further includes providing, at the terminal, a visual code with link information; and reading, by the mobile device, the visual code, wherein providing the communication link includes establishing the communications link between the terminal and the mobile device according to information. In some embodiments, the visual code is a QR code.

In some embodiments, the terminal is a point-of-sale terminal. In some embodiments, the terminal is a computer used in an online transaction. In some embodiments, the mobile device is one of a smart phone, a tablet, or a computer. In some embodiments, the short-range communications link is one of Bluetooth, ultra-wideband (UWB), or near-field communications (NFC). In some embodiments, the transaction is a financial transaction. In some embodiments, the transaction is an access transaction.

In some embodiments, a terminal in a secured transaction system is disclosed. In some embodiments, the terminal includes a processor; a memory coupled to the processor; a card reader coupled to the processor; a short-range interface for short-range communication coupled to the processor; and an internet interface for internet communications coupled to the processor, wherein the processor executes terminal security application instructions stored in the memory for receiving card data from a card presented to the card reader, connecting through the short-range interface with a mobile device, receiving a code and information from the mobile device, sending the code and information to a security application through the internet interface, receiving approval of the transaction from the security application, and completing the transaction.

In some embodiments, a mobile device is presented. The mobile device can include a processor; a memory coupled to the processor; a short-range interface for short-range communication coupled to the processor; and an internet interface for internet communications coupled to the processor, wherein the processor executes mobile security application instructions stored in memory for connecting with a terminal through the short-range interface, transmitting information to the terminal, receiving an approval request from a security application through the internet interface, and providing approval to the security application.

In some embodiments, a cloud server is presented. The cloud server can include a processor; a memory coupled to the processor; an internet interface for internet communications coupled to the processor, wherein the processor executes security application instructions stored in memory for receiving information from a terminal regarding a transaction; verifying accuracy of the information; if verified, communicating with a mobile device to receive user approval; and approving the transaction.

These and other embodiments are discussed below with respect to the following figures.

### BRIEF DESCRIPTION OF THE FIGURES

FIG. 1 illustrates a conventional access card or credit card system.

FIGS. 2A, 2B, 2C, and 2D illustrate an access system and its components according to some embodiments of the present disclosure.

FIG. 3 further illustrates operation of the access system as illustrated in FIG. 2 according to some embodiments of the present disclosure.

FIGS. 4A, 4B, and 4C illustrate operation of each component of the access system illustrated in FIGS. 2A, 2B, 2C, and 2D according to some embodiments of the present disclosure.

FIGS. 5A, 5B, 5C, and 5D illustrates operation for downloading and activating security applications to components of the access system illustrated in FIGS. 2A through 2D according to some embodiments of the present disclosure.

FIGS. 6A, 6B, and 6C illustrate a further example of operation of the access system as illustrated in FIGS. 2A through 2D according to some embodiments of the present disclosure.

FIGS. 7A, 7B, and 7C illustrate communication between components to affect the operation illustrated in FIGS. 6A, 6B, and 6C.

These figures are further discussed below.

### DETAILED DESCRIPTION

In the following description, specific details are set forth describing some embodiments of the present invention. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure.

This description illustrates inventive aspects and embodiments should not be taken as limiting—the claims define the protected invention. Various changes may be made without departing from the spirit and scope of this description and the claims. In some instances, well-known structures and techniques have not been shown or described in detail in order not to obscure the invention.

Embodiments of the present disclosure utilizes a proximately located user-owned mobile device in a validation system to validate a presented access card. Embodiments of the present disclosure supports multiple security use cases, including credit card fraud prevention and secured device or network access situations. Embodiments can take the guesswork out of fraud detection and authenticate a user access (e.g., purchase transaction or access request) on-the-spot in a short period of time. Consequently, embodiments of the present disclosure utilizes the exchange of secured signals between a smart phone and a terminal to authenticate a user and validate a transaction in real time, making it virtually invulnerable to fraud and reduce false declines.

Proximity-based user authentication online or at a physical access terminal (e.g., a point-of-sale terminal) eliminates the acceptance of a costly fraudulent transaction and a false decline of a legitimate purchase attempt that results in lost present and future business. Embodiments of the present disclosure uses a smart phone running an application (app) or with an existing application programming interfaces (APIs). As part of the authentication, a connection that is spatially limited is established between an access terminal and a mobile device that has been authenticated. That connection must be maintained throughout the process, otherwise the access is denied.

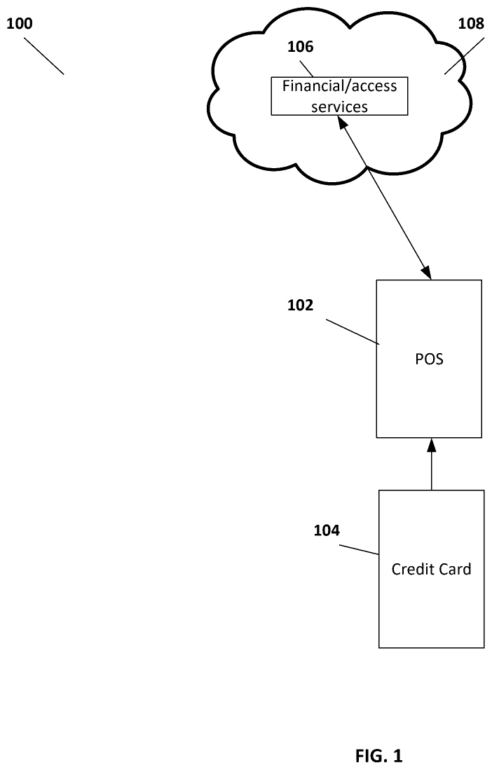

FIG. 1 illustrates a conventional point-of-sale credit card system 100 as an example. As illustrated in FIG. 1, a point-of-sale (POS) terminal 102 is coupled to financial services 106 that is based in cloud 108. A credit card 104 is presented to POS terminal 102 to make payment in a transaction. POS terminal 102 reads the account information from credit card 104 when card 104 is presented to POS 102. Once POS 102 has the account information from card 104, POS 102 communicates with financial services 106 through internet communications between POS 102 and internet-based services in cloud 108 to finalize the transaction. This situation results in a high risk of fraudulent use of the credit card. This results from the situation that the transaction is completed when the card is presented. A similar system can be used for access control (e.g. unlocking gates, opening doors, or providing access to other systems) with similar risks of misuse or fraud.

Although FIG. 1 illustrates specifically the conventional configuration for a credit card payment system, similar figures can illustrate on-line purchases, security access to physical spaces or computer systems, or on-line payments, for example. In those situations, POS 102 can be replaced with a computer system that is being used to access services 106 in cloud 108. In those cases, a user may enter card information into the computer system instead of the computer system reading the card data.

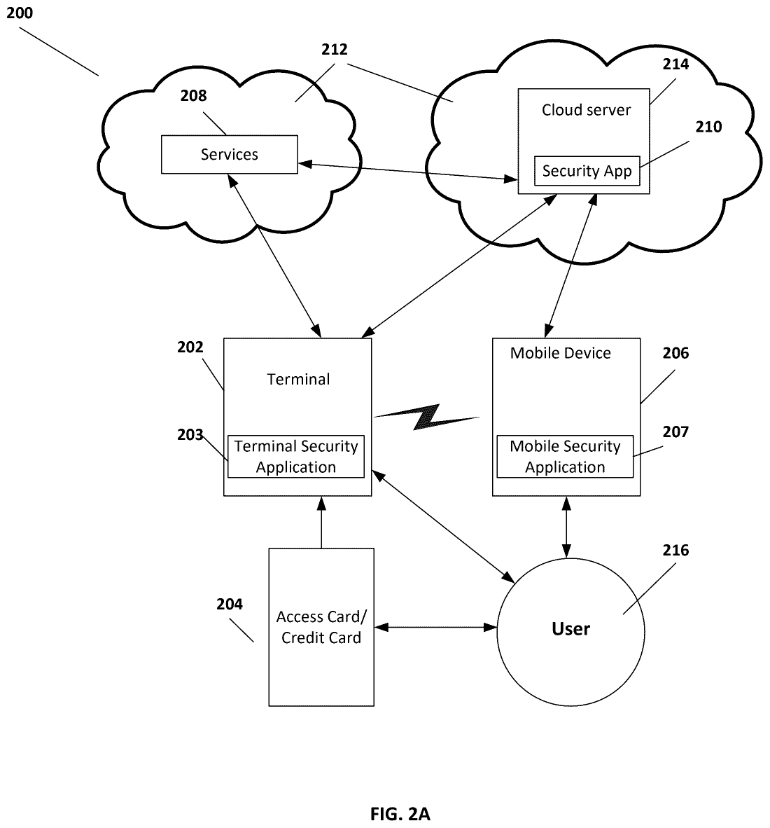

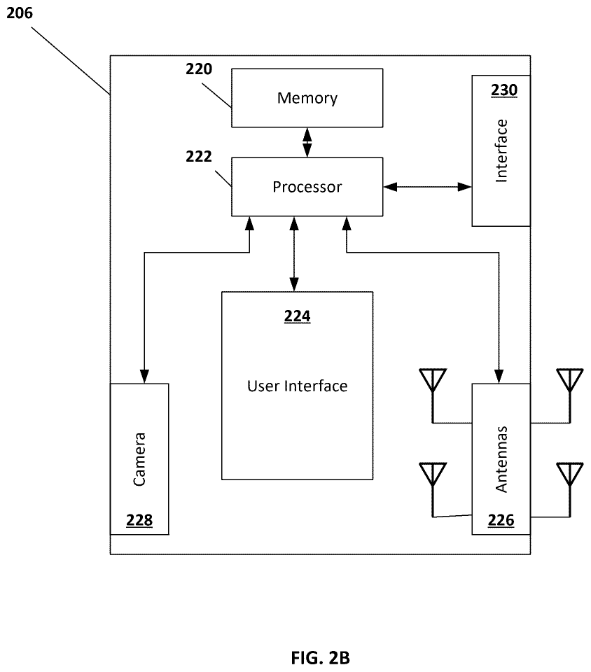

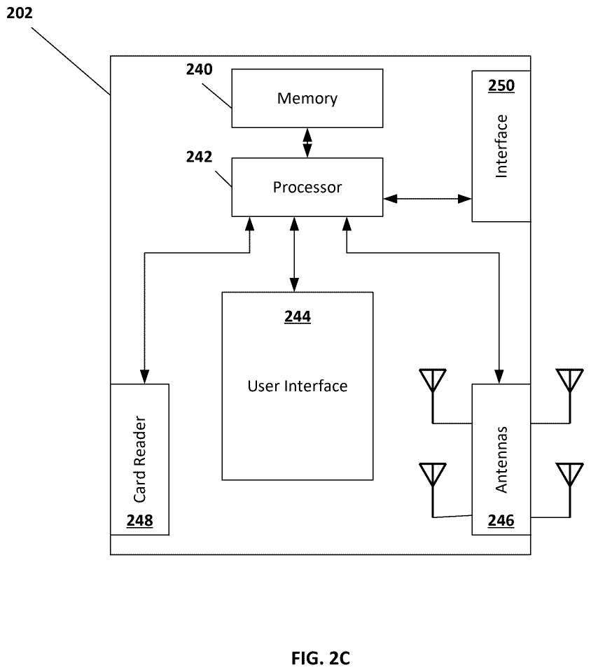

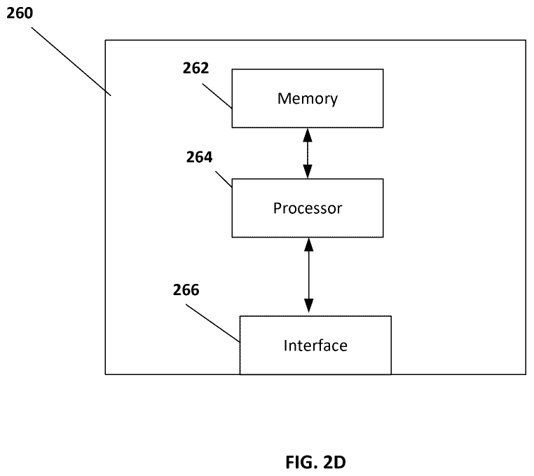

FIG. 2A illustrates an access system 200 according to some embodiments of the present disclosure. As illustrated in FIG. 2A, a terminal 202 operating a terminal security application according to embodiments of the present disclosure is configured to accept a card 204, which can be an access or credit card, and is further configured to communicate with cloud-based services 208 and a cloud-based security application 210 according to embodiments of the present disclosure. Cloud-based services 208 and security application 210 are resident in cloud 214, both of which are accessible through internet access by terminal 202 and both of which communicate with each other through internet access. Terminal 202 can access the internet using any internet communications technology, for example using cell services, WiFi access, dial-up services, broadband services, digital subscriber line (DSL), cable, satellite, integrated services digital network (ISDN), optical fiber based protocols, or other technologies. In this disclosure, references to operations performed by terminal 202 or mobile device 206 refer to execution of terminal security application 203 or mobile security application 207, respectively.

As is illustrated, terminal 202 acquires data that may be stored on card 204. In some embodiments, access card 204 stores account data and may include a number of data storage formats. Such data storage formats may be chips (e.g., using Europay, Mastercard and Visa-EMV-standards), which can be accessed by radio frequency identification (RFID) technologies for example, a magnetic strip, near-field communications (NFC), or any other storage media that may be used to store data on card 204. The data stored on access card 204 can be account information to provide access to services or physical access to an area or credit card information. In some cases, the account information may be stored on mobile device 206 and mobile device 206 may operate in place of access card 204 to provide the account information to terminal 202, for example through NFC communications. In some embodiments, card information from card 204 may be entered manually into terminal 202 by user 216, for example in the case of on-line purchases, financial transfers, or access to online services.

Terminal 202 also is configured to communicate with mobile device 206 when mobile device 206 is located proximate (e.g., within a few meters) of terminal 202. Terminal 202 can communicate with mobile device 206 using any short-range communication technology, for example Bluetooth, ultra-wideband (UWB) standard, near-field communications (NFC), or other wireless technologies. In some cases, a wired communications scheme or a video or optical communications scheme may also be utilized.

Mobile device 206 can be a mobile computing device that is associated with user 216. As illustrated in FIG. 2A, mobile device 206 is configured to communicate with terminal 202 using any short-distance communication technology as described above and is further capable of communicating with security application 210 through any internet communications technology as described above. Furthermore, mobile device 206 may communicate, for example with security application 210, with a messaging service (e.g., SMS).

Security application 210 and services 208 are cloud-based applications that are executed on servers such as cloud server 214. The servers communicate using any internet communications protocol and are accessible by terminal 202 and mobile device 206. In some embodiments, server 214 executing security application 210 can communicate with mobile device 206 using messaging services based on the phone number, for example SMS.

User 216 is associated with mobile device 206 and access card 204. In particular, user 216 presents access card 204 to terminal 202, or alternatively enters card information to terminal 202, to perform a transaction and is in communication with mobile device 206 to respond to queries. In particular, both card 204 and mobile device 206 are carried by user 216 and used to facilitate the transaction using embodiments of the security system according to the present disclosure.

As discussed above, each of terminal 202, mobile device 206, and cloud server 214 operate applications that facilitate embodiments of the security system described in this disclosure. In particular, terminal 202 executes terminal security application 203, mobile device 206 executes mobile security application 207, and cloud server 214 executes security application 210. All communications between terminal 202, mobile device 206, and security app 210 can be encrypted to avoid capture by malicious third parties. In some embodiments, communications with services 208 may also be encrypted. Once a card 204 is provided to terminal 202, terminal 202 establishes communication with mobile device 206. This communication link is maintained throughout the transaction and the transaction is denied if the communication link is broken. The communication link is a short-range link as described above so that the mobile device 206 is maintained proximate to terminal 202 (i.e., within the distance provided by the short-range communications link).

In one embodiment of the communications sequence, once the communication link between terminal 202 and mobile device 206 is established, mobile device 206 provides a unique code to terminal 202, which terminal 202 will transmit to security app 210 in cloud server 214 for approval along with the amount and at least part of the card information read from card 204. Security app 210 then verifies the card and unique code and sends the verified code to mobile device 206. User 216 can then verify the amount to approve on mobile device 206, which is communicated to terminal 202. Terminal 202 then transmits the approval to security application 210 along with the unique code received. Once security application 210 validates the unique code, the transaction proceeds with services 208.

FIG. 2B illustrates an example of a mobile device 206 that can be utilized in embodiments of the present disclosure. Mobile device 206 may be, for example, a smart phone, a tablet, or a computer that is configured to communicate with terminal 202, connecting with internet services such as cloud-based security application 210, and with user 216. Mobile device 206 is configured to download and execute applications that interact with other devices, for example the mobile security application 207 according to some embodiments of the present disclosure.

As shown in FIG. 2B, mobile device 206 includes a processor 222 that is coupled to a memory 220. Memory 220 can be any combination of volatile and non-volatile memory that stores data and instructions that can be executed in processor 222. Processor 222 can include one or more microcomputers, microprocessors, application specific integrated circuits (ASICs), or other controllers capable of performing the steps described in this disclosure.

As is further illustrated in FIG. 2B, processor 222 is coupled to a user interface 224. User interface 224 can be any combination of touch screens, displays, indicators, keyboards, sensors, or other devices capable of communicating with and receiving input from user 216. Processor 222 may also be coupled with a camera 228, which is configured to photograph and provide digital images to processor 222.

Processor 222 is also coupled to an antenna controller 226. Antenna controller 226 includes antennas and data transmission controllers configured for any number of different communications protocols, including, but not limited to, Bluetooth, UWB, NFC, or other wireless technologies. Antenna controller 226 also provides data transmission for WiFi or cell services. Processor 222 may also be coupled to an interface 230, which can provide a wired interface to communicate with other devices. Consequently, mobile device 206 may be capable of connecting to the internet through cell services, WiFi, or other technologies and is capable of short-distance communication, for example through Bluetooth, UWB, NFC, or other technologies as described above. Consequently, mobile device 206 can include internet interfaces for communication with the internet (e.g., antenna controller 226 and interface 230) and short-range interfaces for communicating over short-distance communications (e.g., antenna controller 226 and interface 230). As discussed further below, mobile device 206 executing mobile security application 207 provides short-range communication with terminal 202 and internet communications with security app 210 on cloud server 214. Mobile device 206 also provides encryption for all communications with terminal 204 and security application 210 and communicates through user interface 224 with user 216.

FIG. 2C illustrates an example of a terminal 202 according to some embodiments. As illustrated in FIG. 2C, terminal 202 is an access control terminal, for example a point-of-sale (POS) terminal, a door lock, a terminal providing access to another computer system, a computer system (e.g., a computer, laptop, tablet, smart phone, or other computer device) that is used for online shopping or online access to other services.

As shown in FIG. 2C, terminal 202 includes a processor 242 that is coupled to a memory 240. Memory 240 can be any combination of volatile and non-volatile memory that stores data and instructions that can be executed in processor 242. Processor 242 can include one or more microcomputers, microprocessors, application specific integrated circuits (ASICs), or other controllers capable of performing the steps described in this disclosure. In particular, terminal 202 executes terminal security application 203 that performs the steps described below. Terminal 202 provides short-range communications with mobile device 204 and internet communications with security application 210 as well as services 208. As discussed above, in some embodiments all communications between devices are encrypted. Further, in accordance with the terminal security application 203, the short-range communication with mobile device 204 is monitored and if lost any ongoing transaction is denied.

As is further illustrated in FIG. 2C, processor 242 is coupled to a user interface 244. User interface 244 can be any combination of touch screens, displays, indicators, keyboards, sensors, or other devices capable of communicating with and receiving input from user 216 or other operator of terminal 202.

Processor 242 is also coupled to an antenna controller 246. Antenna controller 246 includes antennas and data transmission controllers configured for any number of different short-range communications protocols, including, but not limited to, Bluetooth, UWB, NFC, or other wireless technologies. Antenna controller 246 may also provide communications through WiFi or cell technologies.

Processor 242 may also be coupled to an interface 250, which can provide any wired interface with other devices, including, for example, mobile device 206 as discussed above. Furthermore, wired internet communications can be provided through interface 250. For example, interface 250 can provide dial-up services, broadband services, digital subscriber line (DSL), cable, satellite, integrated services digital network (ISDN), optical fiber-based protocols, or other technologies.

Consequently, terminal 202 can include internet interfaces for communication with the internet (e.g., antenna controller 246 and interface 250) and short-range interfaces for communicating over short-distance communications (e.g., antenna controller 246 and interface 250).

Processor 242 may further be coupled with a card reader 248, either internally or externally to terminal 202. Card reader 248 can be configured to read data from a card 204 and provide data that was stored on card 204 to processor 242. For example, card reader 248 may read data from a magnetic strip, using near-field communications (NFC), from a chipped card (e.g., using Europay, Mastercard and Visa-EMV-standards), or any other storage media that may be used to store data on card 204. In some embodiments, card data is input by user 216 and terminal 202 does not directly read the data from card 204.

FIG. 2D illustrates an example of cloud server 260. One or more such servers 260 can host services 208 and one or more such servers 260 can be server 214 and host security application 210. As illustrated in FIG. 2D, server 260 includes a processor 264 that is coupled to memory 262 and to an interface 266. Processor 264 can include one or more microcomputers, microprocessors, application specific integrated circuits, or other controllers capable of performing the steps described in this disclosure. Memory 262 can include any combination of volatile and non-volatile memory to store data and programming instructions. Interface 266 can be any interfaces that allow server 260 to communicate with other components that make up the cloud, including interfaces that allow external devices to communicate with the cloud. Security application 210 provides verification and encrypted communications with terminal 202 and mobile device 206 as described below.

As described in further detail below, terminal 202 executes terminal security app 203, mobile device 206 executes mobile security app 207, and the cloud-based server 214 executes security app 210. Communications between these devices are formed through execution of the respective security application on each device.

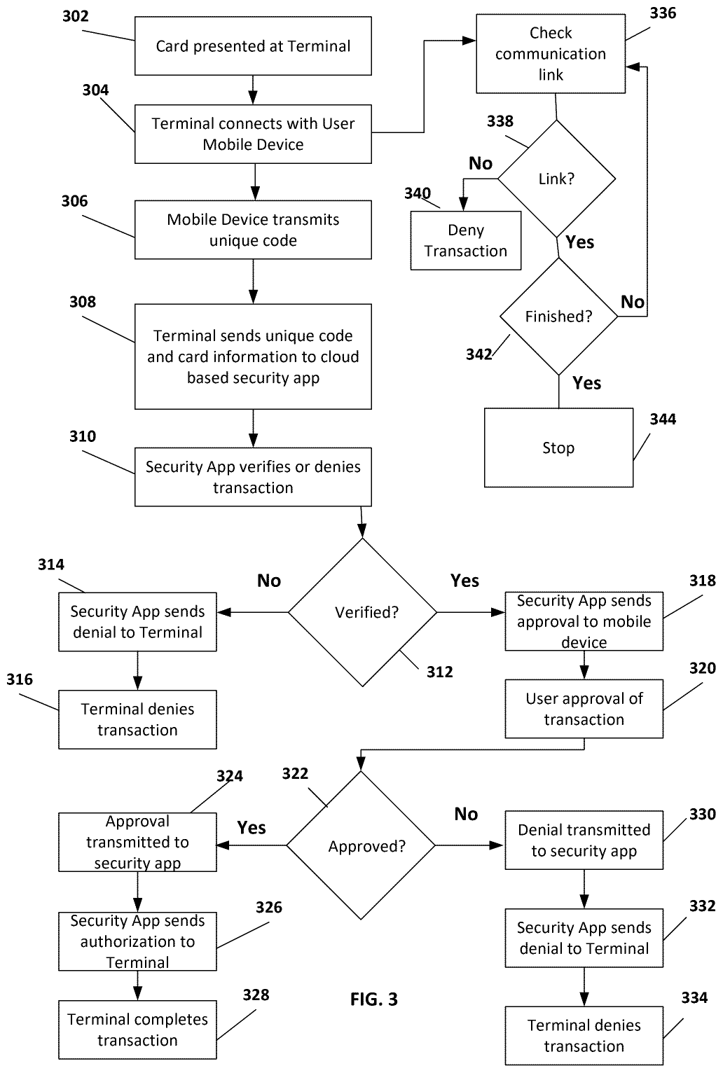

FIG. 3 illustrates an example operation 300 of access system 200 according to some embodiments of the present disclosure. As discussed further below, operation 300 is performed by the cooperative communications between the terminal security application 203 executing on terminal 202, the mobile security app 207 executing on mobile device 206, and security app 210 operating on cloud server 214. As illustrated in FIG. 3, in step 302 card 204 is presented at terminal 202. In general, user 216 initiates the access action through terminal 202 by inserting card 204 into card reader 248 of terminal 202 or “tapping” card 204 onto card reader 248 to be read. In some embodiments, for example for use with on-line purchasing, on-line transactions, or on-line access, card information is entered to terminal 202 by user 216 without terminal 202 actually reading data from card 204. Once card 204 is presented by user 216, then operation 300 proceeds to step 304.

In step 304, terminal 202 establishes short-range communications with mobile device 206. Terminal 202 can connect with mobile device 206 using one of a number of technology standards, including, for example, Bluetooth, UWB, NFC, or other wireless connection that operates with devices that are proximate to terminal 202. Establishment of the short-range communication link between terminal 202 and mobile device 206 also initiates monitoring of the communication link at step 336, discussed further below. However, once the communication link is established, process 300 proceeds also to step 306. In step 306, mobile device 206 transmits a unique code, which for example can be derived from its international mobile equipment identity (IMEI) and phone number. The IMEI and phone number may also be transmitted to terminal 202 by mobile device 206. Operation 300 then proceeds to step 308.

In step 308, terminal 202 transmits the unique code, card information, and if this is a financial transaction the transaction amount to security application 210. Terminal 202 can also send the IMEI and phone number to security application 210 for verification. In step 310, security application 210 verifies and approves the information received from terminal 202. For example, security application 210 verifies card 204 paired with mobile device 206 based on data that has been previously stored by security application 210 during an activation process.

In step 312, if security application 210 is unable to verify the data received from terminal 202, then security application 210 proceed to step 314 where a denial of the transaction is transmitted to terminal 202. In step 316, if terminal 202 receives the denial from security application 210, then terminal 202 denies the transaction in step 316.

In step 312, if security application 210 verifies the information received from terminal 202, then operation 300 proceeds to step 318. In step 318, security application 210 sends an approval inquiry to mobile device 206. In step 320, mobile device 206 requests approval of the transaction from user 216. If the transaction is a financial application, the approval request to mobile device 206 may include the amount of the transaction.

In step 322, if user 216 denies the transaction, then operation 300 proceeds to step 330 where mobile device 206 transmits the denial to security application 210. In step 332, security application 210 sends the denial to terminal 202. In step 334, when terminal 202 receives the denial from security application 210 terminal 202 denies the transaction.

In step 322, if user 216 approves the transaction, then operation 300 proceeds to step 324. In step 324, mobile device 206 transmits the approval to security application 210. In step 326, security application 210 transmits the approval to terminal 326. In step 328, when the approval is received, terminal 202 communications with services 208 to complete the requested transaction and reports completion of the transaction to security application 210.

As discussed above, once the short-range communication link is established between terminal 202 and mobile device 206 in step 304, process 300 initiates monitoring of the link at check step 336. In step 336, process 300 confirms the communication link. In step 338, if the link is lost, then process 300 proceeds to step 340 where the transaction is denied. The denial can be communicated to security app 210 and to terminal 202. If the communication link is maintained, the process 300 proceeds to step 342. In step 342, process 300 confirms that the transaction is ongoing and has not been completed or previously denied. If the transaction is finished, then process 300 proceeds to step 344 and stops. If the transaction has not finished, the process 300 returns to step 336 to again check the existence of the communication link. Consequently, the security process 300 terminates of the communication link between terminal 202 and mobile device 206 is lost. In some embodiments, monitoring of the communication link can be performed in terminal 202, however it may also be monitored by mobile device 206.

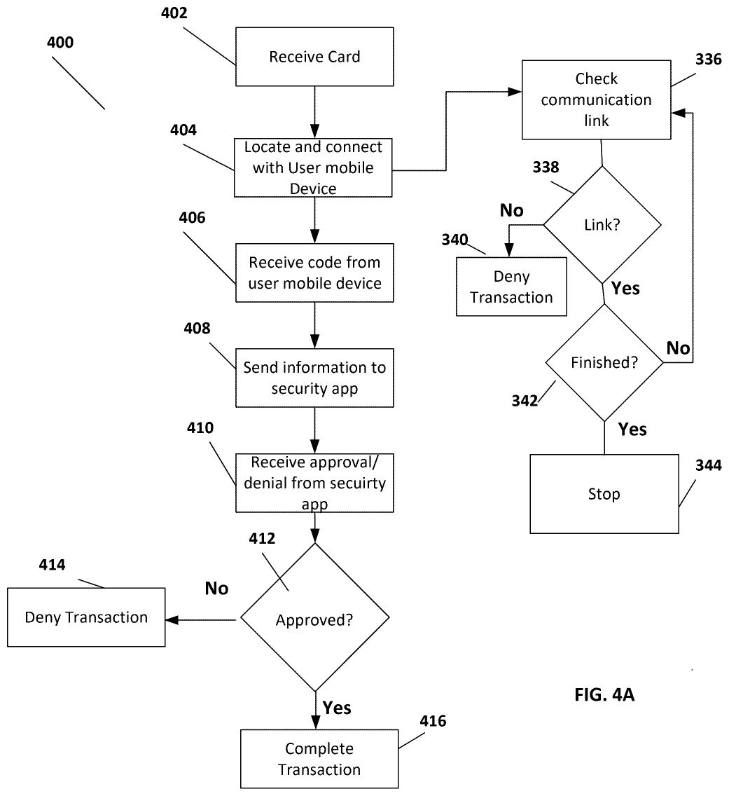

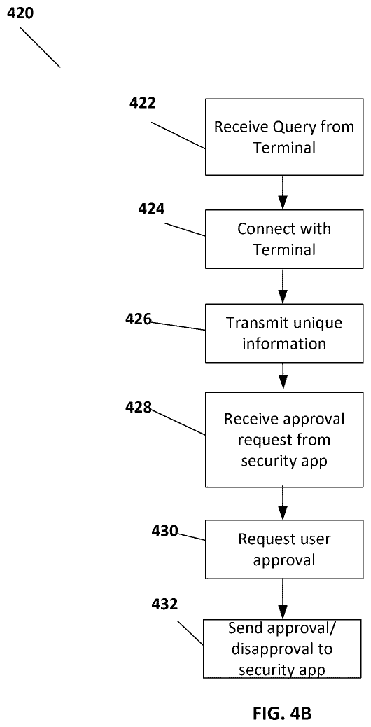

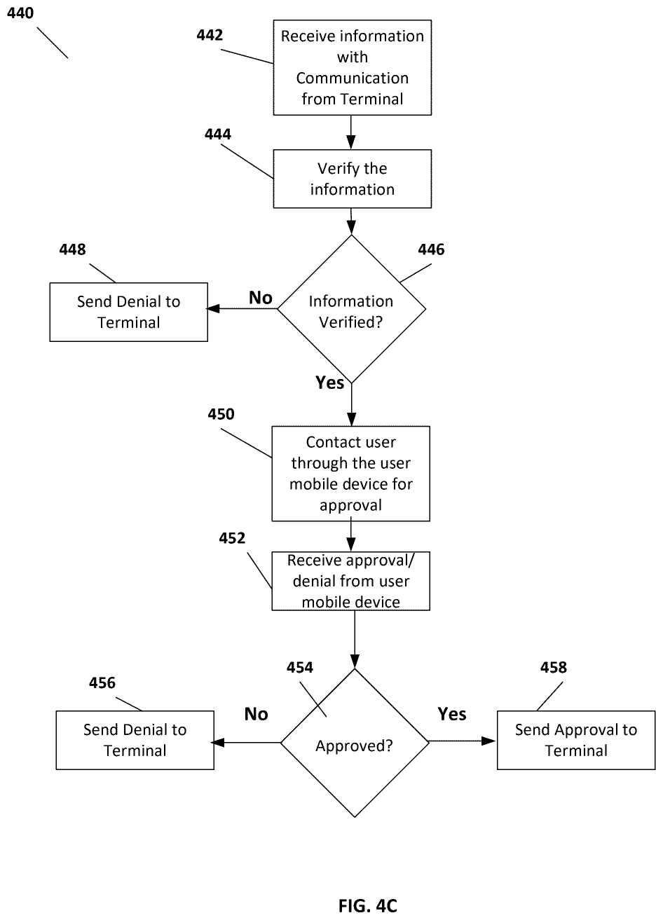

FIGS. 4A through 4C illustrate operations performed on individual components of system 200 as illustrated in FIGS. 2A-2D to perform procedure 300 as indicated in FIG. 3. Each component of system 200 executes its own set of operation steps that contribute to perform operation 300 as illustrated in FIG. 3. In particular, FIG. 4A illustrates operation of the terminal security application 203 executed on terminal 202; FIG. 4B illustrates operation of the mobile security application 207 executed on mobile device 206; and FIG. 4C illustrates execution of security app 210 executed on cloud server 214.

FIG. 4A illustrates operation 400, which is terminal security application 203 executing on terminal 202. As shown in FIG. 4A, operation 400 begins in step 402 where terminal 202 receives card information from card 204. Once information is read from card 204, either by directly reading data from card 204 or by user 216 inputting the information directly to terminal 202, in step 404 terminal 202 identifies and connects with mobile device 206, which is associated with card 204 and user 216. Terminal 202 in step 406 receives a unique code from mobile device 206. Terminal 202 may also receive the IMEI and phone number from mobile device 206.

Once the unique code and other information is received from mobile device 206, terminal 202 transmits the information along with card information read from card 204 to security application 210. As discussed above, communications between terminal 202 and security application 210 is through any internet link. Terminal 202 then waits until it receives confirmation from security application 210. In step 410, therefore, a response is received from security application 210. The response is either an approval of the transaction or a denial of the transaction. In step 412, in the answer from security application 210 is a denial, then terminal 202 denies the transaction in step 414. If the answer from security application 210 is an approval, then terminal 202 completes the transaction in step 416 by communicating with services 208.

As discussed above with respect to FIG. 3, once the short-range communication link is established with mobile device 206 in step 404, operation 400 initiates monitoring of the link at check step 336. In step 336, process 300 confirms the communication link. In step 338, if the link is lost, then process 300 proceeds to step 340 where the transaction is denied. The denial can be communicated to security app 210. If the communication link is maintained, the terminal security application 400 proceeds to step 342. In step 342, terminal security application 400 confirms that the transaction is ongoing and has not been completed or previously denied. If the transaction is finished, then operation 400 proceeds to step 344 and stops. If the transaction has not finished, operation 400 returns to step 336 to again check the existence of the communication link. Consequently, operation 400 terminates if the communication link between terminal 202 and mobile device 206 is lost. In some embodiments, monitoring of the communication link may also be monitored by mobile device 206.

FIG. 4B illustrates operation 420, which is mobile security application 207 executed on mobile device 206. As illustrated in FIG. 4B, operation 420 begins when mobile device 206 receives a query from terminal 202 in step 422. In step 424, mobile device 206 connects with terminal 424. This connection is maintained throughout operation 300, unless terminated by terminal 202 signifying denial of the transaction or completion of the transaction. In some embodiments, operation 420 may monitor the connection between terminal 202 and mobile device 206. However, in the present example, the connection is monitored by terminal 202 as illustrated in FIG. 4A.

In step 426, mobile device 206 transmits a unique code along with its IMEI and phone number. In some cases, the unique code can be derived at least in part on the IMEI and phone number. Mobile device 206 then awaits further processing and, in step 428, receives a request for approval from security application 210. In some embodiments, mobile device 206 is in communication with security application 210 through an internet connection, although an SMS connection or other communications may also be used to communicate with security application 210.

Once the request is received in step 428, mobile device 206 requests approval from user 216 in step 430. In step 432, mobile device 206 transmits the approval or disapproval to security application 210.

FIG. 4C illustrates operation 440, which is security application 210 executed on cloud server 214. As illustrated in FIG. 4C, operation 440 starts in step 442 when security application 210 receives the information sent from terminal 202 through internet communications. In step 444, the information received by security application 210 is verified. In particular, security application 210 includes a databased of data that identifies card 204 that corresponds with the unique code, IMEI, and/or phone number associated with mobile device 206. In step 444, security application 210 cross-references the IMEI, phone number, and/or unique code received from mobile device 206 with the data received from card 204 to verify the match. In particular, security application 210 confirms that the mobile device 206 that is located proximate to terminal 202 is associated with card 204, both of which are associated with user 216. In step 446, if the information is verified then security application 210 transmits a denial to terminal 202 in step 448.

If the information received from terminal 202 is verified, then in step 446 operation 440 proceeds to step 450. In step 450, security application 210 transmits a request for approval to mobile device 206 to contact user 216. In step 452, security application 210 receives an approval or denial from user mobile device 206. In some cases, in step 452 a timeout process may be in effect so that if an answer from mobile device 206 is not received within a preset period of time, then the lack of response is treated as a denial.

In step 454, if security application 210 does not verify the information, then security application 210 proceeds to step 456. In step 456, security application 210 transmits the denial to terminal 202. Further, in step 454, if security application 210 does verify the information, the security application 210 proceeds to step 458 where the approval is transmitted to terminal 202.

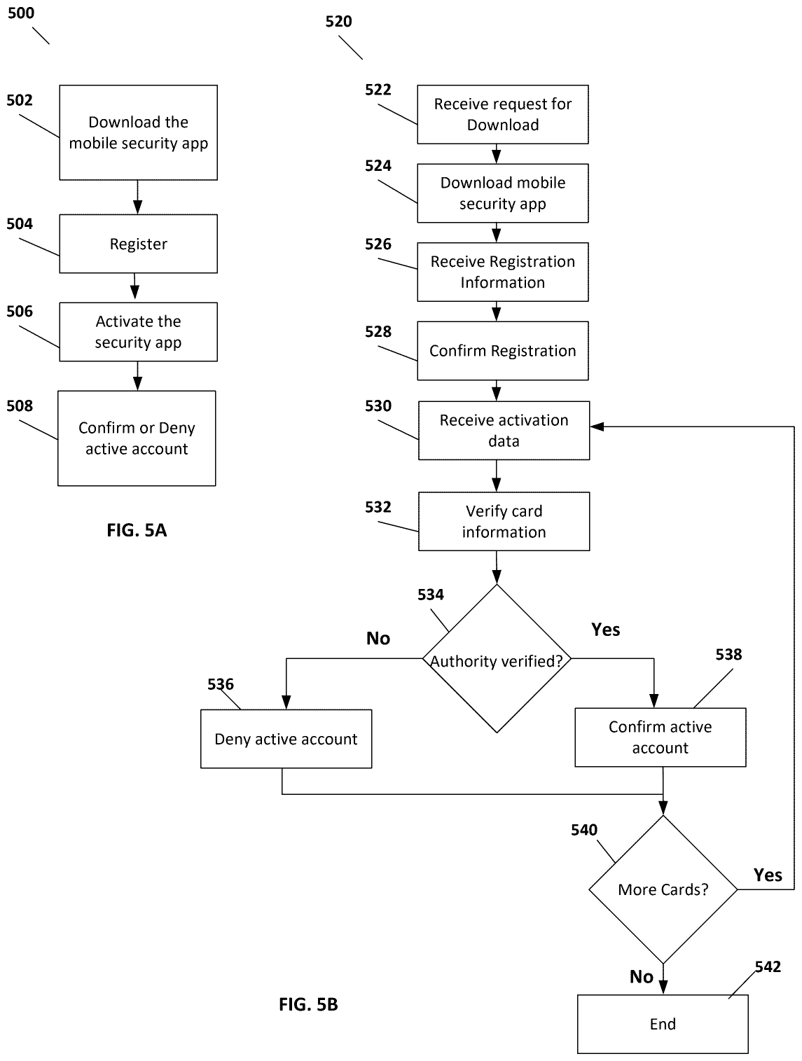

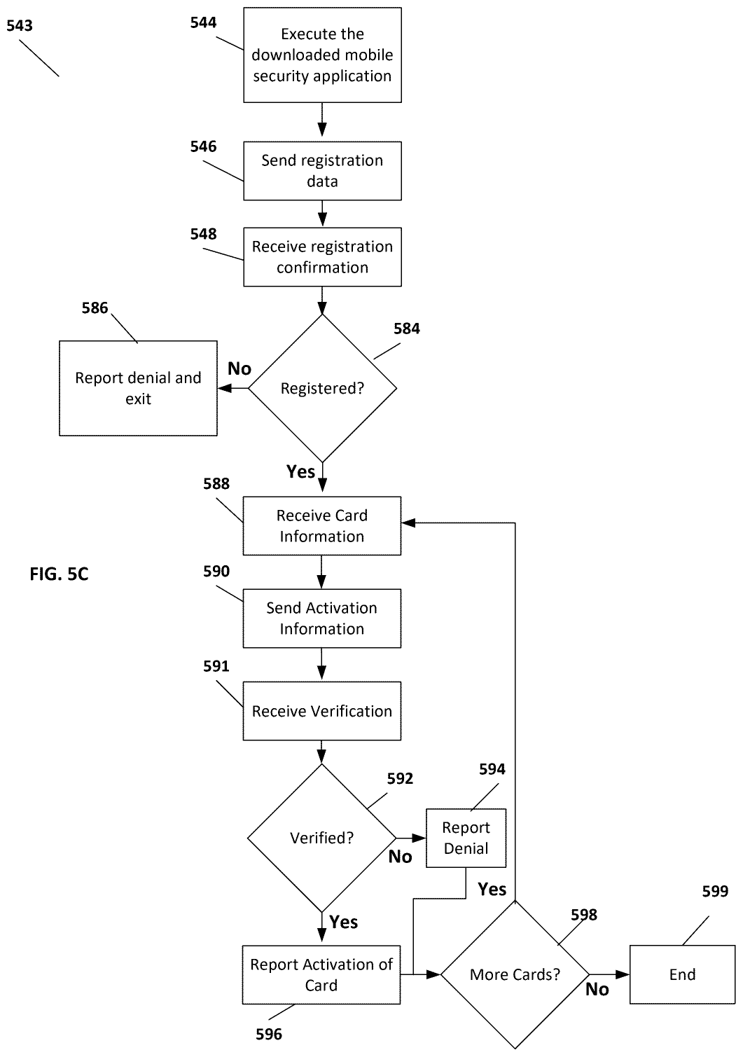

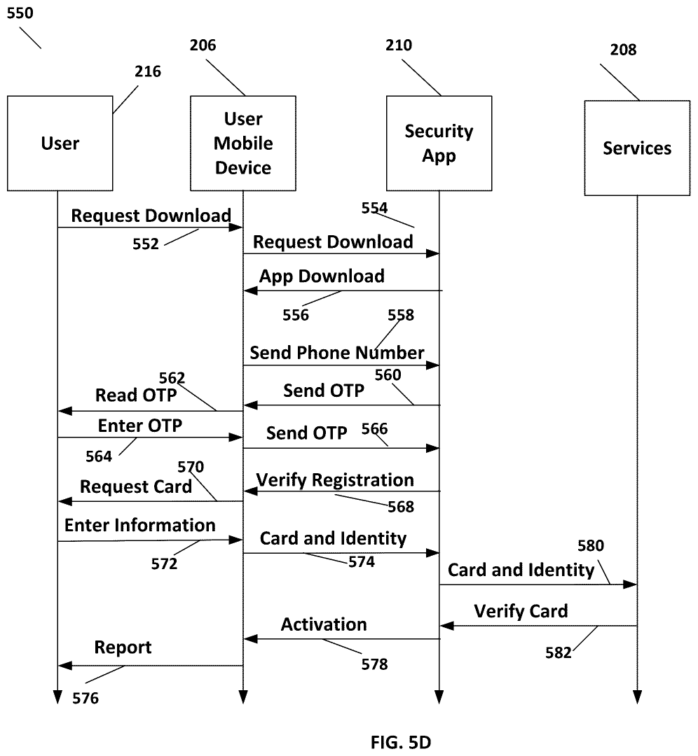

FIGS. 5A-5C illustrate activation of an account with security application 210. As discussed above, operation 300 according to some embodiments of the present disclosure presumes that information regarding mobile device 206 and card 204 have been entered into a databased in memory 262 of cloud server 214 executing security application 210 so that security application 210 can verify information received from terminal 202 regarding card 204 and mobile device 206 is presented. Consequently, in general user 216 and mobile device 206 download the mobile security application from security application 210, registers a card 204, and activates an account prior to performing operation 300.

FIG. 5A illustrates an operation 500 that describes the download of the mobile security application, registration of a card 104, and activation of an account to operate security application 210 with the mobile security application. In step 502 of operation 500, a mobile security application is downloaded to mobile device 502 and executed. This download is initiated on mobile device 206 by user 216. For example, user 216 can request the download through an online store or other internet source. Mobile device 206 then requests the download from security application 214 using an internet connection. In step 504, user 216 is registered. Registration is accomplished by user 216 entering the phone number and verifying with a one-time password that has been transmitted separately to user 216, usually with a text message (SMS) to mobile device 206.

In step 506, an activation process is completed. Activation calls for associating valid information from card 204 with the identifying information received from mobile device 206 and storing that association in security application 210 to be used for future verification procedures. Consequently, activation in step 204 includes user 216 entering access card information for card 204, mobile device 206 transmitting that card information to security application 210, and having security application 210 verify the card information associated with user 216 at services 208. If the information entered for card 204 is confirmed by services 208, the card information can be connected with the user information associated with user 216 and mobile device 206 in security application 210. If not confirmed, then the activation is not achieved and no entry is made in security application 210. A user 216 can enter information from any number of cards 204 and have them linked with the user information in the account during activation, or may enter information for additional cards at a later time through the mobile security application downloaded and operating on mobile device 206.

Once activation is completed, then operation 500 proceeds to step 508. In step 508, security application 210 has determined the validity of the card and matched the card information with the account information (e.g., ID and phone number of mobile device 206 and other data). The validity determination results in confirmation or denial of the activated account in step 508, which is then displayed to user 216. Activation can continue until multiple cards are activated in security application 210.

FIG. 5B illustrates operation 520 that is activated as part of security application 210 to facilitate operation 500 as illustrated in FIG. 5A. As illustrated in FIG. 5B, operation 520 starts in step 522 when security application 210 receives a download request from mobile device 206. In step 524, security application 210 downloads the security application to mobile device 206 and launches the security application for operation on mobile device 206. Further, mobile device 206 transmits the phone number of mobile device 206. In step 524, security application 210 also may transmit a one-time password (OTP) to mobile device 206, for example by transmitting a SMS text message with the OTP to mobile device 206. In step 526, security application 210 receives registration information from mobile device 206 along with the OTP that has been read and entered into the security application operating on mobile device 206 by user 216. As discussed above, the registration information may include the phone number and IMEI for mobile device 206.

In step 528, security application 210 confirms the registration with the OTP and requests activation data from user 216. In step 530, security application 210 receives card information, which has been entered into mobile device 206 by user 216 and transmitted by mobile device 206 to security application 210.

In step 532, security application 210 communicates with services 208 to verify the card information. In step 534, if the card information is verified then security application 210 proceeds to step 538 to confirm the active account. From step 538, security application 210 proceeds to step 540 to confirm if there more cards to be activated on the account. If there is, then operation 510 of security application 210 returns to step 530 to receive further activation data. If not, then operation 510 ends in step 542. In step 534, if the verification has failed, then security application 210 proceeds to step 536 to deny the active account. That denial is typically communicated with mobile device 206. From step 536, operation 510 proceeds to step 540 to determine if there are further cards to be activated.

FIG. 5C illustrates operation 543, which is execution of the mobile security application 207 operating on mobile device 206. In step 544 of operation 543, the now downloaded mobile security application 207 is executed. Since mobile device 206 is not yet registered in security application 210, operation 543 proceeds to step 546. In step 546, registration data is transmitted to security application 210. Registration data can, for example, include the phone number, IMEI, or other identifying data for mobile device 206. In some embodiments, the registration data may also include an OTP that was transmitted to mobile device 206 during download of mobile security application 207 (e.g., by SMS messaging or other methods).

In step 548, mobile device 206 receives confirmation from security application 210 verifying or denying the registration. For example, if the OTP transmitted with the registration data is correct the security application can verify registration but if the OTP is incorrect then the registration will be denied. In step 584, if registration is denied then operation 543 proceeds to step 586 where the denial is communicated to user 216 and operation 543 exits. In step 584, if registration is confirmed then operation 543 proceeds to step 588.

In step 588, card information is received by mobile device 206. In some embodiments, mobile device 206 can read information from card 204 directly. In some embodiments, user 216 enters card information to mobile device 206. In step 590, the card information along with registration information is sent to security application 210.

In step 591, the activation decision is received from security application 210. In step 592, if the card is denied and activation is not verified then operation 543 proceeds to step 594 where the card denial is reported to user 216. If the card is a verified in step 592, then operation 543 proceeds to step 596 where the verification is reported to user 216. From step 596 and step 594, operation 543 proceeds to step 598. In step 598, operation 543 determines whether there are more cards to activate on the registered account. If not, the operation 543 ends in step 599. If there are more cards, the operation 543 returns to step 588 to receive information on another card.

FIG. 5D further illustrates the communications 550 that occurs between user 216, mobile device 206, security application 210, and services 208 in order to register and activate an account for further use. In the diagram illustrated in FIG. 5D, examples of messaging is displayed along timelines that extend from each device. As has been discussed above, user 216 communicates with mobile device 206 through user interface 224 as illustrated in FIG. 2B. Mobile device 206 communicates with security application 210 through internet communications, e.g. by cell service or by WiFi. Mobile device 206 may also receive text messages from security application 210 using, for example, by short message/messaging service (SMS) or by other messenger services. Security application 210 and services 208 communicate through internet communications. Since both security application 210 and services 208 are cloud-based services, they further communicate through the cloud.

As shown in FIG. 5D, communications 550 starts with message 552 where user 216 requests mobile device 206 to download the security application. In message 556, mobile device 206 requests the download of mobile security application 207 from security application 210. In message 556, security application 210 downloads the security application to mobile device 206. Once downloaded, the mobile security application 207 is executed on mobile device 206. In message 558, mobile device 206, executing the downloaded mobile security application 207, transmits its phone number to security application 210.

In message 560, security application 210 transmits the OTP to mobile device 206 through a text message, email, or other method outside of the security application downloaded to mobile device 206. In message 562, mobile device 206 allows user 216 to read the OTP. In message 564, user 216 enters the OTP into the security application executing on mobile device 206.

In message 566, mobile device 206 returns the OTP to security application 210. In some embodiments, mobile device 206 also forwards device information (e.g., the IMEI) with the OTP. In message 568, security application 210 indicates to mobile device 206 that registration has been verified or has not been verified. If registration is verified, message 570 is sent to user 216 requesting card information. In message 572, user 216 enters the card information into mobile device 206. In message 574, mobile device 206 forwards the card information along with other information from mobile device to security application 210. Security application 210 then communicates the card and identity information to services 208 for verification in message 580. In message 582, a verification is sent from services 208 to security application 210. If the card information is verified, then security application 210 sends an activation message in message 578, which is reported to the user in message 576. It should be noted that if the card is not verified, then that messages 578 and 576 convey that decision as well.

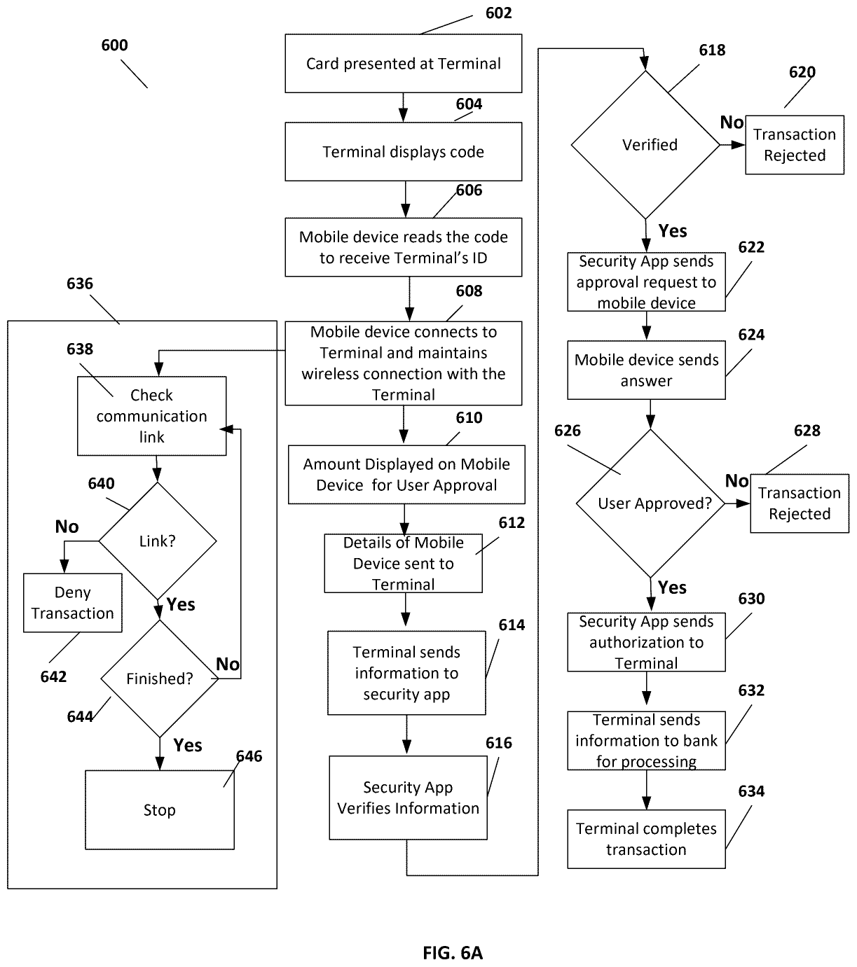

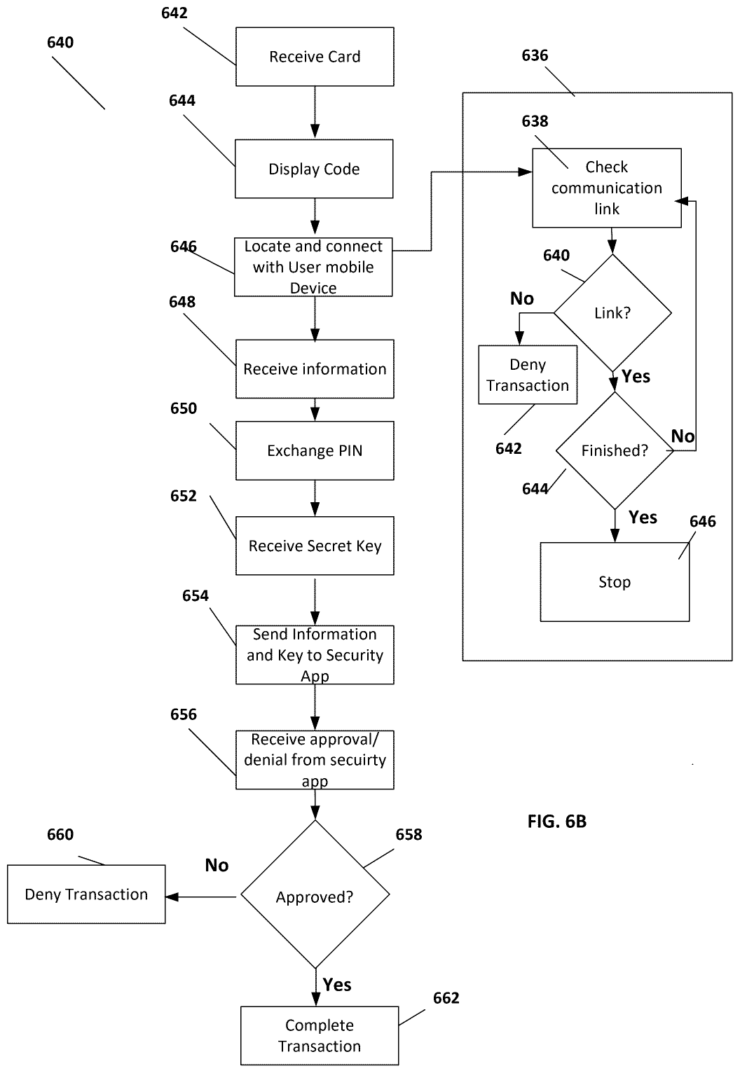

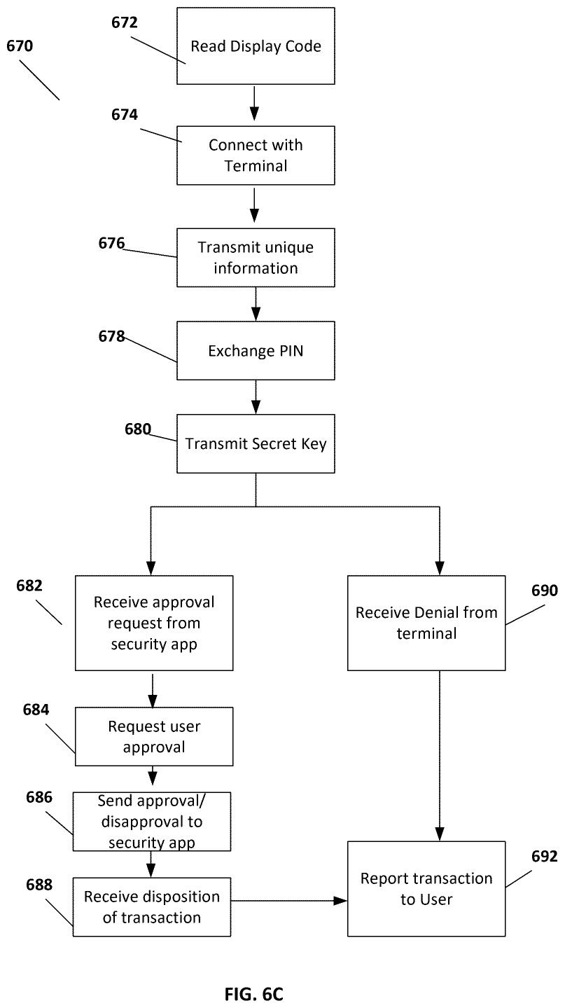

FIG. 6A illustrates another example operation 600 according to some embodiments of the present disclosure. Operation illustrates the interactions between terminal security application 203 executing on terminal 202, mobile security application 207 executing on mobile device 206, and security application 210 executing on cloud server 216 to perform the security application according to embodiments of the present disclosure. As shown in FIG. 6A, operation 600 starts in step 602 when card 204 is presented to terminal 202. When card 204 is presented to terminal 202, terminal 202 reads the card information from card 204. In some embodiments, user 216 may input the data from card 204 directly into terminal 202. For example, for on-line purchases user 216 may input credit card information directly into terminal 202, which can be a computer, tablet, or other devices being used in the purchase.

In the embodiment illustrated in FIG. 6A, in step 604 terminal 202 displays a code using user interface 244 as illustrated in FIG. 2C. The code displayed by terminal 202 includes connection information and, in some embodiments, an amount to be paid. For example, the code can be a QR code that includes a Bluetooth ID of terminal 202 and an amount to be paid. The code is readable by mobile device 106.

In step 606, mobile device 206 reads the code displayed by terminal 202. In some embodiments, mobile device 206 can read the QR code from the downloaded security application using camera 228 of mobile device 206. Mobile device 206 can then extract the connection information and other information such as the amount to be paid in the transaction. In step 608, mobile device 206 connects with terminal 202. While the resulting connection, for example a Bluetooth connection, is maintained between terminal 202 and mobile device 206, mobile device 206 cannot be removed from a terminal 202 by a configurable distance. In accordance with embodiments of the disclosure, mobile device 206 remains proximate to terminal 202 throughout the transaction or the transaction is terminated. Consequently, throughout operation 600, if the connection between terminal 202 and mobile device 206 is lost, then terminal 202 will terminate the transaction. In particular, communication link monitor 636 is initiated when mobile device 206 and terminal 202 are connected in step 608 and operates in parallel throughout the remainder of the transaction.

In monitor 636, operation 600 begins in step 638 where the communication link between terminal 202 and mobile device 206 is checked. In step 640, if the communication link remains active then monitor 636 proceeds to step 644. In step 644, monitor 636 checks to see if the transaction is completed. If it has, then monitor 638 stops in step 646. If not, then monitor 636 proceeds to step 638 to check the link again. In step 640, if the link has been severed, then monitor 636 proceeds to step 642 where the transaction is denied. Consequently, if the communication link is dropped at any time prior to completion of the transaction, then the transaction is denied.

If mobile device 206 receives the amount of the transaction along with the other information in step 606, then in step 610 the amount of the transaction can be displayed to user 216 on user interface 224 of mobile device 206.

In step 612, mobile device 206 transmits information to terminal 202. The information includes identity information such as the phone number, the IMEI, and a Bluetooth ID, which can be used to verify the identity.

From step 612, operation 600 proceeds to step 614 where terminal 202 transmits the information, which may include the identity information, the card information read from card 204, and the transaction amount to security application 210 for verification. In step 616, security application 210 verifies the information and the card information. As discussed above, verification includes insuring that the information identifying mobile device 206 and the card information from card 204 match the account information previously stored by security application 210 during activation of the account.

Operation 600 then proceeds to step 618, where if the transaction is not verified operation 600 proceeds to step 620 to reject the transaction. In step 620, the rejection is communicated to terminal 202 and the connection between terminal 202 and mobile device 206 can be terminated. In step 618, if the transaction is verified then operation 600 proceeds to step 622.

In step 622, security application 600 transmits an approval request to mobile device 206 through an internet connection. Mobile device 206 replies with approval if it remains connected to terminal 202 and if user 216 provides the authorization.

In step 624, mobile device 204 transmits an answer to security application 210. In step 626, if the answer is not approval then operation 600 proceeds to step 628 where the transaction is terminated. If the answer is approval, then operation 600 proceeds to step 630. In step 630, security application 210 transmits the approval to terminal 202.

Once terminal 202 receives an approval in step 630, then terminal 202 can send the card information to services 208 for processing. In step 634, terminal 202 completes the transaction and exits.

FIG. 6B illustrates operation 640 consistent with operation 600 illustrated in FIG. 6A, which is terminal security application 203 operating on terminal 202. Operation 640 begins in step 642 with receipt of card 204 at terminal 202. In step 644, a code (for example a QR code) that provides connection information and in some cases transaction amounts is displayed on terminal 202. In step 646, terminal 202 establishes a communication link with mobile device 206 as discussed above. Further, as discussed in FIG. 6A, terminal 202 monitors the link throughout the transition on monitor step 636, which runs parallel with the transaction and indicates a denial of the transaction if the communication link between terminal 202 and mobile device 206 is lost.

In step 648, terminal 202 receives information from mobile device 206. The information may include the phone number and IMEA of mobile device 206. In some embodiments, in step 650 terminal 202 and mobile device 206 exchange a personal identification number (PIN) and in step 652 terminal 202 receives a secret key from mobile device 206. In step 654, terminal 202 sends the mobile device information, card information, and security code to security application 210. In cases of a financial transaction, the transaction amount may also be transmitted in step 654.

In step 656, terminal 202 waits to receive an approval or denial from security application 210. In some embodiments, a time-out process may begin and the transaction denied if a communication from security application 210 is not received within a specified time. In step 658, if the transaction is denied then operation 640 proceeds to step 660 where the denial is communicated with mobile device 206 and the communications link is terminated. If the transaction is accepted, then operation 640 proceeds to step 662 where the transaction is completed.

FIG. 6C illustrates operation 670, which is mobile security application 207 executing on mobile device 206 as discussed above. In this embodiment, operation 670 begins at step 672, where user 216 uses mobile device 206 to read a visual display code from terminal 202. As discussed previously, the display code can be a QR code or other code that includes link information with terminal 202. In step 674, mobile device 206 establishes a short-range communications link with terminal 202. In some embodiments, mobile device 206 can continuously monitor this link throughout the transaction and discontinues the transaction if the link is lost.

In step 676, mobile device 676 provides the unique device information to terminal 202. The device information can include, for example, the phone number and IMEA number that is unique to mobile device 206. In some embodiments, a PIN may also be exchanged with terminal 202 in step 678. In step 680, mobile device 206 transmits a secret key as discussed above. If a communication is received from terminal 202, then operation 670 proceeds to step 690 to receive a denial from the terminal. Otherwise, mobile device 206 receives a request for approval in step 682.

From step 682, operation 670 request approval of the transaction from user 216. In step 686, the approval or denial of the transaction received from user 216 is transmitted to security application 210 in response to the approval request received from security application 210. In step 688, mobile device 688 receives the disposition of the transaction, which is reported to user 216 in step 692.

Operation of security application 210 on cloud server 214 that is consistent with the examples of terminal security application 203 illustrated in FIG. 6B and mobile security application 207 illustrated in FIG. 6C is illustrated in FIG. 4C. FIG. 4C illustrates operation 440, which illustrates the operation of security application 210 executing on cloud server 214.

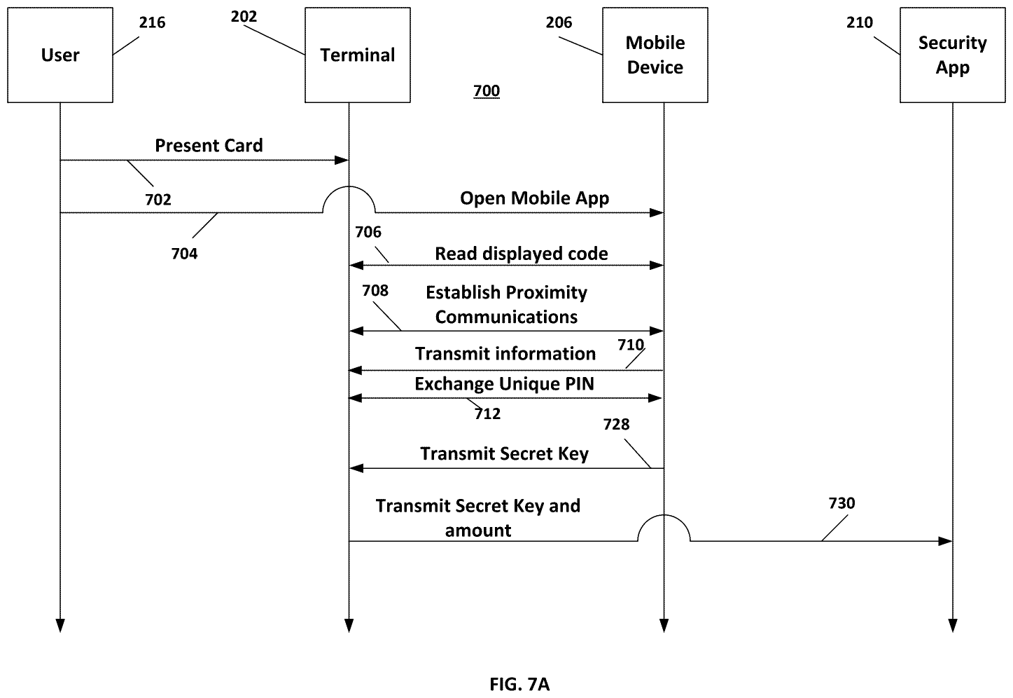

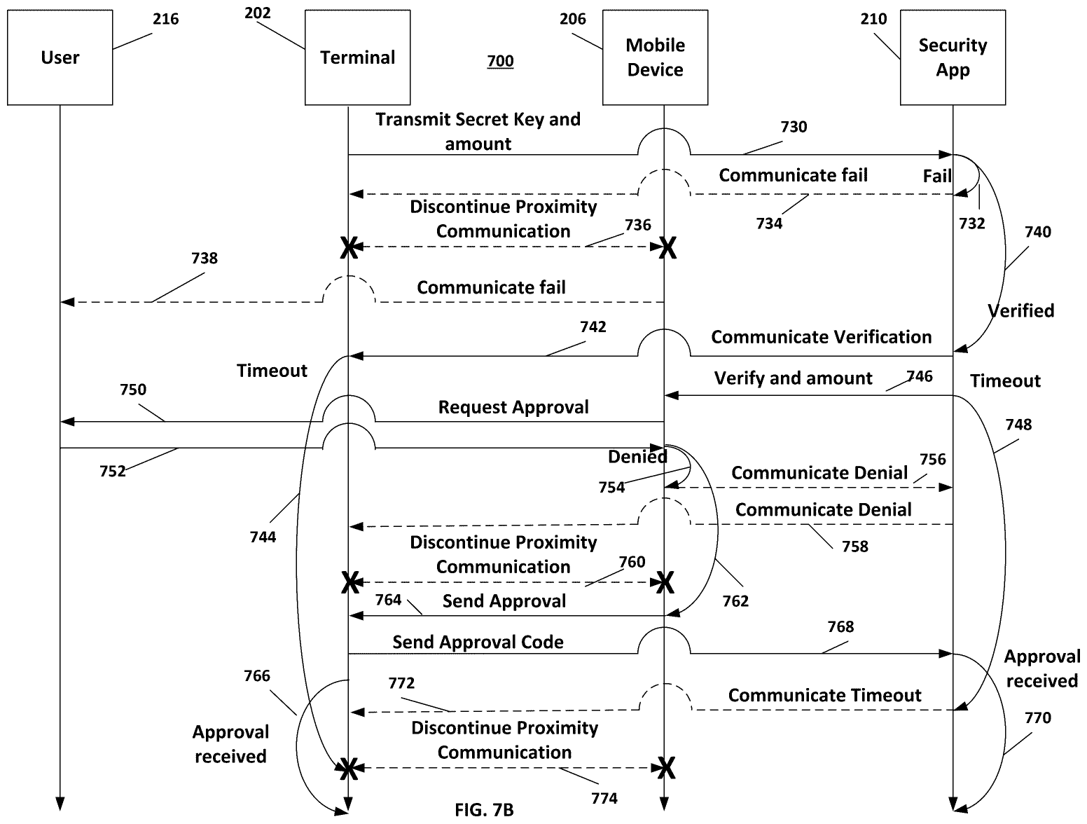

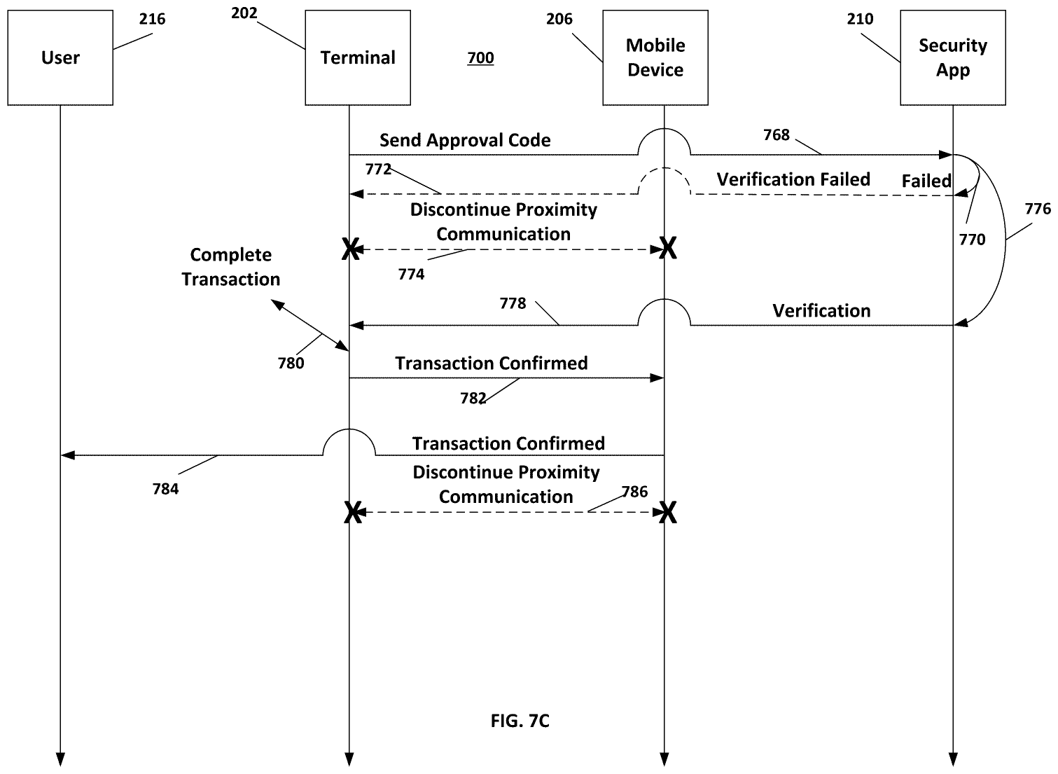

FIGS. 7A through 7C illustrates the communications along a timeline between user 216, terminal 202, mobile device 206, and security application 210 while executing operation 600 as illustrated in FIG. 6A through 6C and FIG. 4C.

As shown in FIG. 6A, communication 700 starts with communication 702 where user 216 presents card 204 at terminal 202. Additionally, in communication 704 user 216 opens the mobile security application on mobile device 206, which has been previously downloaded to provide for an active account with security application 210. In communication 706 mobile device 206 reads the code that is displayed by terminal 202, which often involves user 216 placing mobile device 206 such that camera 228 reads the code displayed on user interface 244. As discussed above, the code may include the amount of the transaction and connection information (e.g. Bluetooth IDs, unique PINs, and other data). In some embodiments, the code can be a QR code, however other methods of visually transmitting data can be used.

Once mobile device 206 has read the displayed code and extracted the information, in communications 708 terminal 202 and mobile device 206 establish a communications link. In some embodiments, this is a Bluetooth link, however other short-distance standards can be utilized such as NFC, UWB, or other protocols.

In communications 710, mobile device 206 transmits identifying information, for example the phone number, device ID, MAC ID, IMEI, or other identifier for mobile device 206. In some embodiments, in communications 712 a unique personal identification number (PIN) number that is associated with the current transaction can be exchanged. In some cases, this PIN number can be generated by terminal 202 based on card information read from card 204 and device information transmitted from mobile device 206. However, the PIN in most cases is unique to the particular transaction that is underway.

In some embodiments mobile device 206 generates a secret key from the phone number, IMEI number, and Bluetooth ID of mobile device 206. The secret key can be encrypted, for example with an RSA encryption using public/private keying, and transmitted to terminal 202 over the communications link in communication 728. Terminal 202 can transmit this information along with the amount and card information to security application 210 in communication 730.

As illustrated in FIG. 7B, after communication 730 security application 210 verifies the transaction. If verification fails, then communication 700 follows path 732 and, in communication 734, the failure is communicated to terminal 202. In communication 736, terminal 202 discontinues the communication connection between terminal 202 and mobile device 206. In some embodiments, the failure is communicated by mobile device 206 to user 216 in communications 738.

If security application 210 verifies the communication, then communication 700 follows path 740 and security application 210 communicates the verification to terminal 202 in communication 742. Security application 210 also requests verification by mobile device 206 in communication 746. In some embodiments, mobile device 206 requests approval from user 216 in communication 750, to which user 216 can respond in communication 752. In some embodiments, since user 216 has already approved the result, communications 750 and 752 are not included and mobile device 206 denies or approves the transaction based on the continued existence of the proximity communication link with terminal 202 indicating that mobile device 206 remains proximate to terminal 202.

Communication 742 can initiate a time-out process 744 at terminal 202. If final approval is not received in time, then at the end of time-out process 744 in communication 774 terminal 202 discontinues the communication link with mobile device 206 in communication 774.

Communication 746 can also initiate a time-out process 748 at security application 210. If the approval code is not received in security application 210 before the end of time-out process 748, then security application 210 sends a communication timeout to terminal 202 in communication 772. In response to communication 772, terminal 202 discontinues the communication link with mobile device 206 in communication 774.

If mobile device 206 denies the transaction, then path 754 is taken. With path 754, mobile device 206 communicates the denial to security application 210 in communication 756. Security application 210 then communicates the denial to terminal 202 in communication 758, after which terminal 202 discontinues the communication link between terminal 202 and mobile device 206 in communication 760.

Alternatively, if mobile device 206 verifies the transaction then path 762 is taken. In the embodiment illustrated in FIG. 7B, in path 762 mobile device transmits an approval to terminal 202 in communications 764. In communications 768, terminal 202 sends an approval code to security application 210. Terminal 202 then proceeds along path 766 and security application 210 proceeds along path 770. The approval code can, for example, be the security code that was earlier generated by mobile device 206 and transmitted to terminal 202 in communications 728.

As illustrated in FIG. 7C, when security application 210 receives communications 768 with the approval code, security application 210 verifies the approval code. When the approval code is the secret code sent earlier, then the verification involves comparing the codes. If the verification fails, then path 770 is taken and security application 210 transmits notice of failure to terminal 202 in communication 772. When terminal 202 receives communication 772, then terminal 202 discontinues the communications connection with mobile device 206 in communication 774.

In security application 210, if the approval code is verified then path 776 is taken where verification is transmitted to terminal 202 in communication 778. When verification is received by terminal 202, then terminal 202 communicates with services 208 in communication 780. When the transaction is completed, then terminal 202 transmits a confirmation in communication 782 to mobile device 206. Mobile device 206 then communicates the transaction completion to user 216 in communication 784. In communications 786, the communications link between terminal 202 and mobile device 206 can be terminated.

In accordance with some embodiments of the present application, the following aspects are presented:

Aspect 1: A method of securing a transaction, comprising: receiving data from a card at a terminal to initiate a transaction; providing a short-range communications link between a mobile device and the terminal, the mobile device being proximate to the terminal and associated with the user; transmitting, by the mobile device, a unique code to the terminal; transmitting, by the terminal, information including the unique code to a cloud based security application; verifying, at the cloud based security application, the information; requesting, by the cloud-based security application, approval of the mobile device; approving, by the mobile device, the transaction; if authorization is provided, transmitting the authorization to the terminal; if authorization is provided, transmitting from the terminal the unique code to the cloud-based security application; verifying, at the cloud-based security application, the unique code; if verified, the security application transmitting an approval to the terminal; and completing the transaction, by the terminal, when the approval is received.

Aspect 2: The method of Aspect 1, further including providing, at the terminal, a visual code with link information; and reading, by the mobile device, the visual code, wherein providing the communication link includes establishing the communications link between the terminal and the mobile device according to information.

Aspect 3: The method of Aspects 1-2, wherein the visual code is a QR code.

Aspect 4: The method of Aspects 1-3, wherein the terminal is a point-of-sale terminal.

Aspect 5: The method of Aspects 1-4, wherein the terminal is a computer used in an online transaction.

Aspect 6: The method of Aspects 1-5, wherein the mobile device is one of a smart phone, a tablet, or a computer.

Aspect 7: The method of Aspects 1-6, wherein the short-range communications link is one of Bluetooth, ultra-wideband (UWB), or near-field communications (NFC).

Aspect 8: The method of Aspects 1-7, wherein the transaction is a financial transaction.

Aspect 9: The method of Aspects 1-8, wherein the transaction is an access transaction.

Aspect 10: A terminal in a secured transaction system, comprising a processor; a memory coupled to the processor; a card reader coupled to the processor; a short-range interface for short-range communication coupled to the processor; and an internet interface for internet communications coupled to the processor, wherein the processor executes terminal security application instructions stored in the memory for receiving card data from a card presented to the card reader, connecting through the short-range interface with a mobile device, receiving a code and information from the mobile device, sending the code and information to a security application through the internet interface, receiving approval of the transaction from the security application, and completing the transaction.

Aspect 11: A mobile device, comprising: a processor; a memory coupled to the processor; a short-range interface for short-range communication coupled to the processor; and an internet interface for internet communications coupled to the processor, wherein the processor executes mobile security application instructions stored in memory for connecting with a terminal through the short-range interface, transmitting information to the terminal, receiving an approval request from a security application through the internet interface, and providing approval to the security application.

Aspect 12: A cloud server, comprising: a processor; a memory coupled to the processor; an internet interface for internet communications coupled to the processor, wherein the processor executes security application instructions stored in memory for receiving information from a terminal regarding a transaction; verifying accuracy of the information; if verified, communicating with a mobile device to receive user approval; and approving the transaction.

Embodiments of the invention described herein are not intended to be limiting of the invention. One skilled in the art will recognize that numerous variations and modifications within the scope of the present invention are possible. Consequently, the present invention is set forth in the following claims.

What is claimed is:

1. A method of securing a transaction, comprising:
receiving data from a card at a terminal to initiate a transaction;
providing a short-range communications link between a mobile device and the terminal, the mobile device being proximate to the terminal and associated with the user;
transmitting, by the mobile device, a unique code to the terminal;
transmitting, by the terminal, information including the unique code to a cloud based security application;
verifying, at the cloud based security application, the information;
requesting, by the cloud-based security application, approval of the mobile device;
approving, by the mobile device, the transaction;
if authorization is provided, transmitting the authorization to the terminal;
if authorization is provided, transmitting from the terminal the unique code to the cloud-based security application;
verifying, at the cloud-based security application, the unique code;
if verified, the security application transmitting an approval to the terminal; and
completing the transaction, by the terminal, when the approval is received.

2. The method of claim 1, further including providing, at the terminal, a visual code with link information; and
reading, by the mobile device, the visual code,
wherein providing the communication link includes establishing the communications link between the terminal and the mobile device according to information.

3. The method of claim 2, wherein the visual code is a QR code.

4. The method of claim 1, wherein the terminal is a point-of-sale terminal.

5. The method of claim 1, wherein the terminal is a computer used in an online transaction.

6. The method of claim 1, wherein the mobile device is one of a smart phone, a tablet, or a computer.

7. The method of claim 1, wherein the short-range communications link is one of Bluetooth, ultra-wideband (UWB), or near-field communications (NFC).

8. The method of claim 1, wherein the transaction is a financial transaction.

9. The method of claim 1, wherein the transaction is an access transaction.

10. A terminal in a secured transaction system, comprising
a processor;
a memory coupled to the processor;
a card reader coupled to the processor;
a short-range interface for short-range communication coupled to the processor; and
an internet interface for internet communications coupled to the processor,
wherein the processor executes terminal security application instructions stored in the memory for
receiving card data from a card presented to the card reader,
connecting through the short-range interface with a mobile device,
receiving a code and information from the mobile device,
sending the code and information to a security application through the internet interface,
receiving approval of the transaction from the security application, and
completing the transaction.

11. A mobile device, comprising:
a processor;
a memory coupled to the processor;
a short-range interface for short-range communication coupled to the processor; and
an internet interface for internet communications coupled to the processor,
wherein the processor executes mobile security application instructions stored in memory for
connecting with a terminal through the short-range interface,
transmitting information to the terminal,
receiving an approval request from a security application through the internet interface, and
providing approval to the security application.

12. A cloud server, comprising:
a processor;
a memory coupled to the processor;
an internet interface for internet communications coupled to the processor,
wherein the processor executes security application instructions stored in memory for receiving information from a terminal regarding a transaction;
verifying accuracy of the information;
if verified, communicating with a mobile device to receive user approval; and
approving the transaction.
